(19) United States
(12) Patent Application Publication
(10) Pub. No.: US 2019/0366476 A1
(43) Pub. Date: Dec. 5, 2019

(54) LASER OSCILLATOR

(71) Applicant: FANUC CORPORATION, Yamanashi (JP)

(72) Inventor: Tetsuhisa TAKAZANE, Yamanashi (JP)

(73) Assignee: FANUC CORPORATION, Yamanashi (JP)

(21) Appl. No.: 16/407,215

(22) Filed: May 9, 2019

(30) Foreign Application Priority Data
May 29, 2018 (JP) 2018-102242

(51) Int. Cl. B23K 26/062; H01S 3/13; H01S 3/067; H01S 3/23; B23K 26/38

(52) U.S. Cl. CPC B23K 26/062; H01S 3/1305; B23K 26/38; H01S 3/23; H01S 3/067

(57) ABSTRACT

A laser oscillator which can be protected appropriately from reflected light is provided. A laser oscillator includes a plurality of light detection sensors that detect intensities of different wavelengths of leaking light leaking from an optical fiber that emits a laser beam via filters having different properties, and a control unit that stops oscillation of the laser beam when the intensity of the leaking light detected by any one of the plurality of light detection sensors exceeds a threshold set to each of the light detection sensors.

This application is based on and claims the benefit of priority from Japanese Patent Application No. 2018-102242, filed on 29 May 2018, the content of which is incorporated herein by reference.

### BACKGROUND OF THE INVENTION

### Field of the Invention

The present invention relates to a laser oscillator having a protection function from a reflected light.

### Related Art

Conventionally, a laser oscillator which uses an optical fiber and is used for welding or cutting metal or plastics machines a target object with a laser power exceeding 1 kW. Such a laser oscillator has a high laser power, a reflected light reflected from a target object and returning to the laser oscillator may damage the laser oscillator. Therefore, the laser oscillator has a function of stopping oscillation of laser light upon detecting a reflected light having an intensity exceeding a threshold (for example, see Patent Document 1).

Patent Document 1: Japanese Unexamined Patent Application, Publication No. 2013-146752

### SUMMARY OF THE INVENTION

However, since the intensity and the wavelength of reflected light are various depending on the type of laser machining, it is difficult to set an appropriate threshold. There are problems that the threshold is not appropriate in such a way that the laser oscillator is not protected if the threshold is low whereas the laser oscillator stops unnecessarily and an operation rate decreases if the threshold is high.

An object of the present invention is to provide a laser oscillator which can be protected appropriately from reflected light.

(1) A laser oscillator (for example, a laser oscillator 1 to be described later) according to the present invention includes: a plurality of sensors (for example, light detection sensors 40 to be described later) that detect intensities of different wavelengths of leaking light leaking from an optical fiber (for example, an optical fiber 30 to be described later) that emits a laser beam via filters (for example, filters 41 to be described later) having different properties; and a control unit (for example, a control unit 50 to be described later) that stops oscillation of the laser beam when the intensity of the leaking light detected by any one of the plurality of sensors exceeds a threshold set to each of the sensors.

(2) In the laser oscillator according to (1), the plurality of sensors may have different sensitivities for respective wavelengths.

(3) The laser oscillator according to (1) or (2) may further include a beam combiner (for example, a beam combiner 20 to be described later) that combines a plurality of laser beams, and certain sensors among the plurality of sensors may be disposed in an incidence-side port of the beam combiner.

(4) In the laser oscillator according to any one of (1) to (3), a threshold for the sensor that detects an oscillation wavelength of the laser beam may be set to be lower than a threshold for the sensor that detects a wavelength different from the oscillation wavelength.

(5) The laser oscillator according to any one of (1) to (4) may further include a storage unit (for example, a storage unit 60 to be described later) that stores a plurality of pieces of time-series data detected by the plurality of sensors corresponding to different wavelengths, and the control unit may determine similarity of waveforms of the plurality of pieces of time-series data and sets a threshold for the sensor that detected similar waveforms to be higher than a threshold for the other sensors.

(6) In the laser oscillator according to (5), the control unit may normalize a predetermined period of waveforms of the time-series data and determine that the waveforms are similar when a value obtained by integrating a difference between intensities for the predetermined period is smaller than a predetermined value.

(7) In the laser oscillator according to any one of (1) to (6), the control unit may change the threshold according to input machining conditions.

According to the present invention, it is possible to protect a laser oscillator appropriately from reflected light.

### BRIEF DESCRIPTION OF THE DRAWINGS

FIG. 1 is a diagram illustrating a configuration of a laser oscillator according to a first embodiment.

FIG. 2 is a diagram illustrating an arrangement example of light detection sensors in an optical fiber according to the first embodiment.

FIG. 3 is a diagram illustrating a machining condition table in which a relation between thresholds and machining conditions according to the first embodiment is defined.

FIG. 4 is a diagram illustrating a configuration of a laser oscillator according to a second embodiment.

### DETAILED DESCRIPTION OF THE INVENTION

### First Embodiment

Hereinafter, a first embodiment of the present invention will be described. FIG. 1 is a diagram illustrating a configuration of a laser oscillator 1 according to the present embodiment. The laser oscillator 1 includes laser cavities (LCs) 10, a beam combiner (BC) 20, an optical fiber 30, a light detection sensor 40, a filter 41, a control unit 50, and a storage unit 60. The laser oscillator 1 combines laser beams generated by the LC 10 using the BC 20 so that the combined laser beam propagates through the optical fiber 30.

Although a laser beam is used for machining, welding or the like, light may return to the optical fiber 30 as well as the reflected light from a target object, due to scattering, emission of light resulting from heating at a machining point, plasma emission, and generation of second-order harmonics. If the intensity is high, the returning light may damage the BC 20 or the LC 10. A plurality of light detection sensors 40 (for example, light detection sensors 40a and 40b) is disposed in a portion where light is likely to leak outside such as a welding point of the optical fiber 30. The light detection sensor 40 is a photodiode or the like, for example, and measures a light intensity by detecting a current value or the like that changes according to a light intensity.

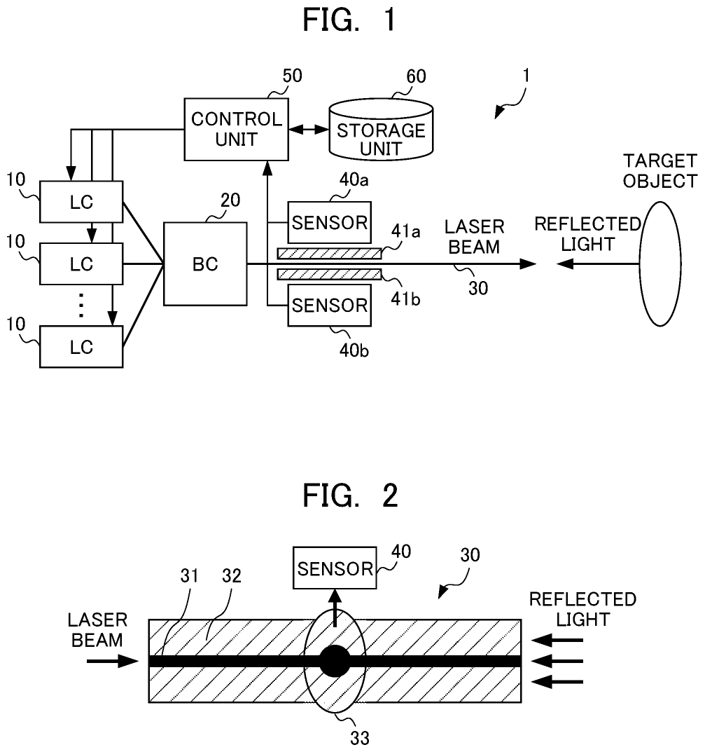

FIG. 2 is a diagram illustrating an arrangement example of the light detection sensors 40 in the optical fiber 30 according to the present embodiment. A laser beam (direct light) generated by the laser oscillator 1 is incident on a core 31 of the optical fiber 30 and a returning light such as a reflected light from a target object is incident on the core 31 and a clad 32. The direct light and returning light are likely to leak outside from the welding point 33 (particularly, the clad 32) of the optical fiber 30. Therefore, the light detection sensor 40 is disposed in the welding point 33 to detect the intensity of leaking light correlated with the light intensity in the clad 32 mainly occupied by the returning light.

Here, the plurality of light detection sensors 40 detect the light intensities of different wavelengths via filters having different properties. The plurality of light detection sensors 40 may have different sensitivities for respective wavelengths.

For example, since sensitivity to a specific wavelength is different depending on the type of photodiodes, a light detection sensor 40 which has satisfactory sensitivity to a wavelength to be detected is selected. Furthermore, the light detection sensor 40 can detect a light intensity of a specific wavelength selectively using an appropriate filter 41 (for example, filters 41a and 41b) such as a high-pass filter, a low-pass filter, or a band-pass filter.

The control unit 50 stops oscillation of a laser beam by the LC 10 when the intensity of leaking light detected by any one of the plurality of light detection sensors 40 exceeds a threshold set for each sensor. Here, since the reflected light from a target object within the returning light has the highest intensity and is highly likely to damage the laser oscillator 1 since it does not involve conversion, control based on the detection value of the same wavelength as the laser beam is performed preferentially.

Specifically, the threshold for the light detection sensor 40 that detects the oscillation wavelength of a laser beam is set to be lower than the threshold for the light detection sensor 40 that detects a wavelength different from the oscillation wavelength. For example, when the oscillation wavelength is 1070 nm, the threshold for wavelengths of 600 nm, 1150 nm, and 1500 nm is set to 100 μW whereas the threshold for the wavelength of 1070 nm is set to 50 μW.

The control unit 50 changes the threshold set to each light detection sensor 40 according to input machining conditions such as a machining content and the type of laser beam.

The storage unit 60 stores various pieces of data and software for performing the control method of the control unit 50. The thresholds for the respective light detection sensors 40 are also stored in the storage unit 60 and are referred to from the control unit 50.

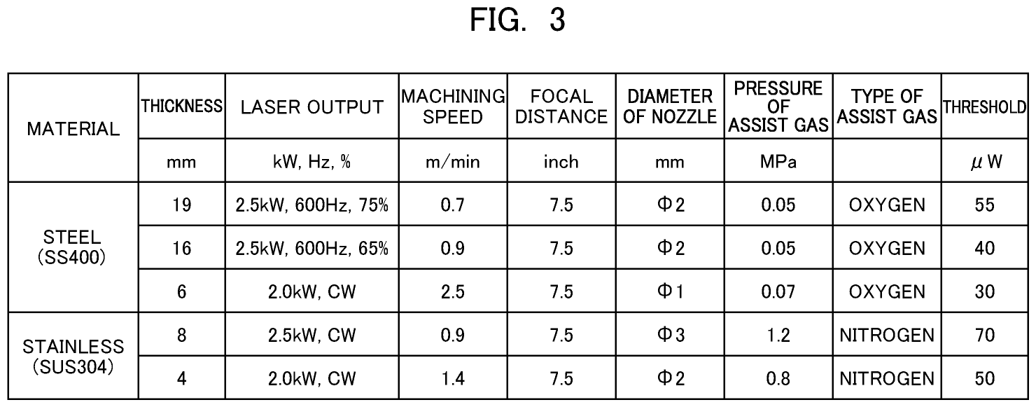

FIG. 3 is a diagram illustrating a machining condition table in which a relation between thresholds and machining conditions according to the first embodiment is defined. In this example, a threshold for a light intensity of an oscillation wavelength is set for each of machining conditions including a material and a thickness of a machining target object, a laser output, a frequency, a duty, a machining speed, a focal distance of a focusing lens, a diameter of a machining nozzle, and the type and the pressure of assist gas. Here, a threshold may be set for light intensities of wavelengths different from the oscillation wavelength in correlation with each light detection sensor 40 and may be calculated by a predetermined calculation formula.

A threshold for stopping oscillation of a laser beam is obtained by accumulating data obtained by actual machining. A user may adjust the threshold appropriately depending on a situation.

According to the present embodiment, the laser oscillator 1 detects the intensities of different wavelengths of leaking light from an optical fiber using filters having different properties and stops oscillation of laser beam when the intensity of the leaking light detected by any one of the plurality of light detection sensors 40 exceeds a threshold set for each light detection sensor 40. Therefore, the laser oscillator 1 can detect the light intensities of a plurality of wavelengths, set the threshold for a specific wavelength such as an oscillation wavelength of a laser beam separately from the thresholds for other wavelengths, and stop oscillation of a laser beam appropriately depending on the risk of damage. As a result, the laser oscillator 1 can be protected from reflected light appropriately and can suppress a decrease in an operation rate resulting from unnecessary stopping of oscillation of a laser beam and realize stable operation.

Since the light detection sensors 40 have different sensitivities for respective wavelengths, the light detection sensors 40 can detect different specific wavelengths by being combined with filters that transmit different wavelengths. Therefore, the laser oscillator 1 can detect light intensities of a plurality of wavelengths selectively and determine the operability of the laser oscillator 1 appropriately by providing independent thresholds for the respective wavelengths.

Since the threshold for an oscillation wavelength of a laser beam is set to be lower than the thresholds for other wavelengths, the laser oscillator 1 is sensitive to a reflected light having the highest intensity within the returning light and can stop oscillation of a laser beam appropriately and can operate stably without stopping oscillation of the laser beam of returning light of other wavelengths unnecessarily.

The laser oscillator 1 can determine operability appropriately using the thresholds of respective wavelengths appropriate for the use state of a laser beam by changing the threshold depending on machining conditions.

### Second Embodiment

Hereinafter, a second embodiment of the present invention will be described. In the present embodiment, an arrangement of the light detection sensors 40 is different from that of the first embodiment.

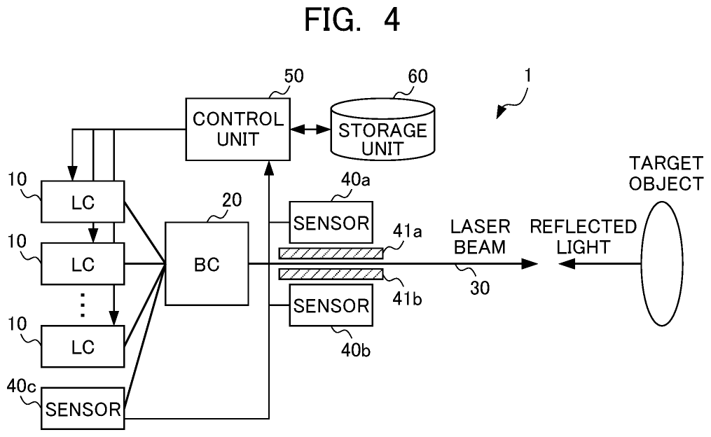

FIG. 4 is a diagram illustrating a configuration of the laser oscillator 1 according to the present embodiment. A light detection sensor 40c for detecting at least a light intensity of an oscillation wavelength among a plurality of light detection sensors 40 is disposed in an incidence-side port of the BC 20.

The BC 20 has a structure optimized for the wavelengths of laser beams generated in order to combine laser beams generated by the LC 10. Therefore, the transmittance in the BC 20 in wavelengths other than the wavelength of a laser beam is lower than the transmittance in the wavelength of the laser beam. The light detection sensor 40c is attached to one of the ports close to the LC 10, of the BC 20 whereby the light detection sensor 40c can detect returning light in which the components other than the reflected light having the same wavelength as the generated laser beam are attenuated.

When the light detection sensor 40c is disposed in parallel to the LC 10, since the returning light is attenuated by being branched, it is possible to suppress the risk that the input to the light detection sensor 40c is excessive. Furthermore, the input to the light detection sensor 40c may be attenuated by providing a neutral density (ND) filter or the like.

According to the present embodiment, since the light detection sensor 40 is disposed in the port close to the LC 10, of the BC 20, since the components other than the oscillation wavelength of the laser beam are attenuated, the laser oscillator 1 can detect the intensity of the reflected light solely with high accuracy and determine the operability appropriately.

### Third Embodiment

Hereinafter, a third embodiment of the present invention will be described. In the present embodiment, a threshold is set using a predetermined period of time-series data of the detection values obtained by the light detection sensor 40.

The storage unit 60 stores a plurality of pieces of time-series data detected by the plurality of light detection sensors 40 corresponding to different wavelengths.

The control unit 50 determines the similarity of waveforms of the plurality of pieces of stored time-series data and sets the threshold for the light detection sensor 40 in which similar waveforms are detected to be higher than the thresholds for the other light detection sensors 40.

Specifically, the control unit 50 determines that the waveforms are similar when a predetermined period of waveforms of the time-series data are normalized and a value obtained by integrating the difference of intensities for a predetermined period is smaller than a predetermined value. For example, values normalized at time t, of two pieces of time-series data of a(t) and b(t) are a(t)/Σa(t) and b(t)/Σb(t), respectively. An integration of the absolute value of the difference between both values is Σ|a(t)/Σa(t)−b(t)/Σb(t)|.

When the waveforms are similar, returning light in a wide range of wavelengths is detected, and it can be determined that the returning light is not reflected light in which light having the same wavelength as the laser beam is a main beam. In this case, since the risk of damage to the laser oscillator 1 is low, the control unit 50 sets the threshold for determination to be relatively high. On the other hand, when the waveforms are not similar, since returning light of a specific wavelength is detected, and the risk of damage to the laser oscillator 1 is high, the threshold for determination is set to be relatively low.

According to the present embodiment, the laser oscillator 1 stores time-series data of the detected light intensity for the respective light detection sensors 40 (that is, for respective wavelengths). When waveforms of pieces of time-series data are compared and are determined to be similar, since it can be determined that the returning light is returning light including a wide range of wavelengths and is not returning light made up of the specific wavelength that can damage the laser oscillator 1, the laser oscillator 1 sets the threshold to be high. In this way, the laser oscillator 1 can suppress unnecessary stopping of operation.

The laser oscillator 1 normalizes the waveforms of pieces of time-series data and determines the similarity of the waveforms on the basis of a value obtained by integrating a difference between the normalized values for a predetermined period. Therefore, the laser oscillator 1 can determine the risk of returning light easily and continuously using a predetermined period of detection data and can apply the determination results to thresholds. As a result, the laser oscillator 1 can determine the operability more appropriately.

While embodiments of the present invention have been described, the present invention is not limited to the above-described embodiments. An effect described in the embodiment of the present invention is just a description of the most preferable effect generated by the present invention and an effect of the present invention is not limited to what has been described in the embodiment.

### EXPLANATION OF REFERENCE NUMERALS

1: Laser oscillator

10: Laser cavity

20: Beam combiner

30: Optical fiber

40: Light detection sensor

41: Filter

50: Control unit

60: Storage unit

What is claimed is:

1. A laser oscillator comprising:
a plurality of sensors that detect intensities of different wavelengths of leaking light leaking from an optical fiber that emits a laser beam via filters having different properties; and
a control unit that stops oscillation of the laser beam when the intensity of the leaking light detected by any one of the plurality of sensors exceeds a threshold set to each of the sensors.

2. The laser oscillator according to claim 1, wherein
the plurality of sensors have different sensitivities for respective wavelengths.

3. The laser oscillator according to claim 1, further comprising:
a beam combiner that combines a plurality of laser beams, wherein
certain sensors among the plurality of sensors are disposed in an incidence-side port of the beam combiner.

4. The laser oscillator according to claim 1, wherein
a threshold for the sensor that detects an oscillation wavelength of the laser beam is set to be lower than a threshold for the sensor that detects a wavelength different from the oscillation wavelength.

5. The laser oscillator according to claim 1, further comprising:
a storage unit that stores a plurality of pieces of time-series data detected by the plurality of sensors corresponding to different wavelengths, wherein
the control unit determines similarity of waveforms of the plurality of pieces of time-series data and sets a threshold for the sensor that detected similar waveforms to be higher than a threshold for the other sensors.

6. The laser oscillator according to claim 5, wherein
the control unit normalises a predetermined period of waveforms of the time-series data and determines that the waveforms are similar when a value obtained by integrating a difference between intensities for the predetermined period is smaller than a predetermined value.

7. The laser oscillator according to claim 1, wherein
the control unit changes the threshold according to input machining conditions.
